(19) United States
(12) Patent Application Publication
(10) Pub. No.: US 2025/0158934 A1
(43) Pub. Date: May 15, 2025

(54) METHODS AND APPARATUSES FOR SUPPORTING A PACKET DISCARDING OPERATION IN A PDCP LAYER DUE TO A PACKET LOSS

(71) Applicant: Lenovo (Beijing) Limited, Beijing (CN)

(72) Inventors: Congchi Zhang, Shanghai (CN); Mingzeng Dai, Shanghai (CN); Lianhai Wu, Beijing (CN); Jing Han, Beijing (CN)

(73) Assignee: Lenovo (Beijing) Limited, Beijing (CN)

(21) Appl. No.: 18/722,362

(22) PCT Filed: Dec. 23, 2021
(86) PCT No.: PCT/CN2021/140926

§ 371 Date: Jun. 20, 2024

(51) Int. Cl. H04L 47/32; H04W 28/02; H04W 80/02

(52) U.S. Cl. CPC H04L 47/323; H04W 28/0242; H04W 28/0278; H04W 80/02

(57) ABSTRACT

Embodiments of the present application relate to methods and apparatuses for supporting a packet discarding operation in a packet data convergence protocol (PDCP) layer due to a packet loss. According to an embodiment of the present application, a PDCP receiving entity includes a processor and a transceiver coupled to the processor; and the processor is configured: to detect a packet loss or to receive, via the transceiver from a PDCP transmitting entity, parameter information regarding a discarding operation of the PDCP receiving entity, wherein the packet loss or the discarding operation is associated with a packet; and to perform the discarding operation to discard a further packet related to the packet in a receiving buffer, in response to detecting the packet loss or in response to receiving the parameter information.

### TECHNICAL FIELD

Embodiments of the present application generally relate to wireless communication technology, in particular to methods and apparatuses for supporting a packet discarding operation in a packet data convergence protocol (PDCP) layer due to a packet loss.

### BACKGROUND

Extended reality (XR), including augmented reality (AR) and virtual reality (VR), as well as cloud gaming (CG), presents a new promising category of connected devices, applications, and services. As a potential working area of 3GPP (3rd generation partnership project) Rel-18, application and traffic awareness in radio access network (RAN) is one of key feature to improve user experience of XR services.

XR services require high bit rate with bounded latency. Typically, the applications require a certain minimum granularity of application data to be available on the client side before the next level of processing can start. This minimum granularity of application data is referred to an application data unit (ADU). The high bit rates may lead to that a large ADU will be transmitted in several IP packets. When these IP packets arrive to RAN, RAN will treat all the packets as if they are uncorrelated from each other. In some embodiments, the ADU represents a group of pictures (GOP) for video service. Groups of pictures (GOPs) are grouped together in ways that enhance the visual result of a video sequence. GOPs may include various types of pictures, such as, intra-coded pictures (I-frame), predictive coded pictures (P-frame), or B-predictive coded pictures (B-frame). Encoders use groups of pictures and other tools to render smoothly streaming video. Frame rates and other metrics may also apply.

Depending on the encoding mechanisms, frames in the same ADU or GOP may be correlated to each other. For instance, if the I-frame is lost, the user will not be able to decode the subsequent P-frames and B-frames. In the meanwhile, due to the nature of wireless communication, a packet loss may happen in the UL or DL transmission. To simplify the data processing at the transmitting or receiving side, upon the data loss of an important packet (e.g., I-frame in one ADU/GOP), there may be no need to continue processing the other correlated packets (e.g., P-frame, B-frame in the same ADU/GOP).

Given the above, it is desirable to provide a mechanism for supporting a packet discarding operation in a PDCP layer due to a packet loss.

### SUMMARY

Some embodiments of the present application also provide a packet data convergence protocol (PDCP) receiving entity. The PDCP receiving entity includes a processor and a transceiver coupled to the processor; and the processor is configured: to detect a packet loss or to receive, via the transceiver from a PDCP transmitting entity, parameter information regarding a discarding operation of the PDCP receiving entity, wherein the packet loss or the discarding operation is associated with a packet; and to perform the discarding operation to discard a further packet related to the packet in a receiving buffer, in response to detecting the packet loss or in response to receiving the parameter information.

Some embodiments of the present application provide a method, which may be performed by a PDCP receiving entity. The method includes: detecting a packet loss or receiving, from a PDCP transmitting entity, parameter information regarding a discarding operation of the PDCP receiving entity, wherein the packet loss or the discarding operation is associated with a packet; and determining to perform the discarding operation to discard a further packet related to the packet in a receiving buffer, in response to detecting the packet loss or in response to receiving the parameter information.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned method performed by a PDCP receiving entity.

Some embodiments of the present application also provide a PDCP transmitting entity. The PDCP transmitting entity includes a processor and a transceiver coupled to the processor; and the processor is configured: to detect a packet loss, to determine to perform a discarding operation of the PDCP transmitting entity, or to receive, via the transceiver from a PDCP receiving entity, parameter information regarding the discarding operation of the PDCP transmitting entity, wherein the packet loss or the discarding operation is associated with a packet; and to stop transmitting a further packet related to the packet in a transmitting buffer and to perform a further discarding operation to discard the further packet, in response to detecting the packet loss or in response to determining to perform the discarding operation or in response to receiving the parameter information.

Some embodiments of the present application provide a method, which may be performed by a PDCP transmitting entity. The method includes: detecting a packet loss, determining to perform a discarding operation of the PDCP transmitting entity, or receiving, from a PDCP receiving entity, parameter information regarding the discarding operation of the PDCP transmitting entity, wherein the packet loss or the discarding operation is associated with a packet; and stopping transmitting a further packet related to the packet in a transmitting buffer and performing a further discarding operation to discard the further packet, in response to detecting the packet loss or in response to determining to perform the discarding operation or in response to receiving the parameter information.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a PDCP transmitting entity.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present application.

FIG. 2 illustrates an exemplary block diagram of an apparatus according to some embodiments of the present application.

FIG. 3 illustrates an exemplary flow chart for a packet discarding operation according to some embodiments of the present application.

FIG. 4 illustrates a further exemplary flow chart for a packet discarding operation according to some embodiments of the present application.

FIG. 5 illustrates an exemplary flow chart of a packet discarding operation in a PDCP receiving entity according to some embodiments of the present application.

FIG. 6 illustrates an exemplary flow chart of a packet discarding operation in a PDCP transmitting entity according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

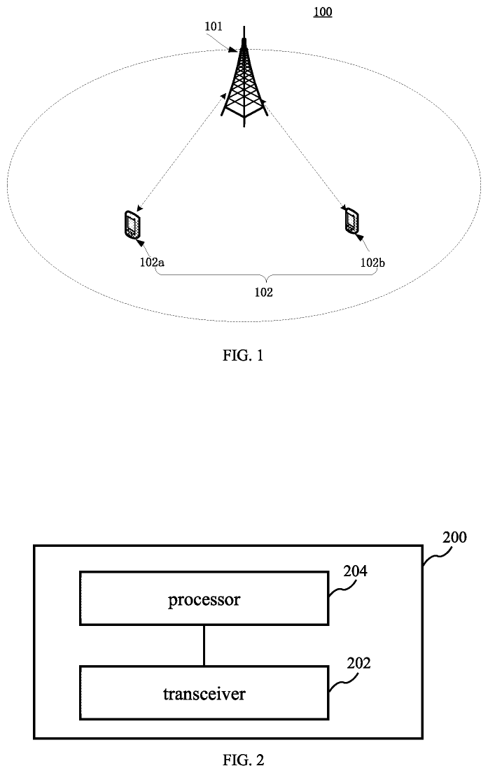

FIG. 1 illustrates a schematic diagram of a wireless communication system according to some embodiments of the present application. As shown in FIG. 1, the wireless communication system 100 includes at least one base station (BS) 101 and at least one user equipment (UE) 102. In particular, the wireless communication system 100 includes one BS 101 and two UE 102 (e.g., UE 102a and UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

BS 101 may communicate with a core network (CN) node (not shown), e.g., a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g., during a handover procedure for a UE.

UE 102, e.g., UE 102a and UE 102b, should be understood as any type terminal device, which may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, UE 102 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE 102 may include wearable devices, such as smart watches, fitness bands, optical head-mounted displays, or the like. Moreover, UE 102 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 102 may communicate directly with BSs 101 via uplink (UL) communication signals.

In general, 3GPP standard document TS38.323 defines data transfer procedures of PDCP transmission and reception operations. For example, at reception of a PDCP SDU from upper layers, the transmitting PDCP entity shall start timer discardTimer associated with this PDCP SDU (if configured). For a PDCP SDU received from upper layers, the transmitting PDCP entity shall associate the COUNT value corresponding to TX NEXT to this PDCP SDU. At reception of a PDCP Data PDU from lower layers, the receiving PDCP entity shall determine the COUNT value of the received PDCP Data PDU, i.e., ROVD_COUNT. When timer t-Reordering expires, the receiving PDCP entity shall deliver to upper layers in ascending order of the associated COUNT value after performing header decompression, if not decompressed before: all stored PDCP SDU(s) with associated COUNT value(s)<RX_REORD; and all stored PDCP SDU(s) with consecutively associated COUNT value(s) starting from RX_REORD); the receiving PDCP entity shall update RX_DELIV to the COUNT value of the first PDCP SDU which has not been delivered to upper layers, with COUNT value>=RX_REORD; and the receiving PDCP entity shall update RX_REORD to RX_NEXT and start timer t-Reordering if RX_DELIV<RX_NEXT.

Regarding a SDU discarding operation, when timer discardTimer expires for a PDCP SDU, or the successful delivery of a PDCP SDU is confirmed by a PDCP status report, the transmitting PDCP entity shall discard the PDCP SDU along with the corresponding PDCP Data PDU. If the corresponding PDCP Data PDU has already been submitted to lower layers, the discard is indicated to lower layers. For a signaling radio bearer (SRB), when upper layers request a PDCP SDU discard, the PDCP entity shall discard all stored PDCP SDUs and PDCP PDUs.

Regarding a status reporting operation, for a data radio bearer (DRB) configured by upper layers to send a PDCP status report in the uplink (statusReportRequired in 3GPP TS38.331 [3]), the receiving PDCP entity shall trigger a PDCP status report. During compiling the PDCP status report, the receiving PDCP entity shall set the FMC field to RX_DELIV; and if RX_DELIV<RX_NEXT, the receiving PDCP entity shall allocate a Bitmap field of length in bits equal to the number of COUNTs from and not including the first missing PDCP SDU up to and including the last out-of-sequence PDCP SDUs, rounded up to the next multiple of 8, or up to and including a PDCP SDU for which the resulting PDCP Control PDU size is equal to 9000 bytes, whichever comes first; the receiving PDCP entity shall set in the bitmap field as ‘0’ for all PDCP SDUs that have not been received, and optionally PDCP SDUs for which decompression have failed; and the receiving PDCP entity shall set in the bitmap field as ‘1’ for all PDCP SDUs that have been received. For DRBs, when a PDCP status report is received in the downlink or in the sidelink, the transmitting PDCP entity shall consider for each PDCP SDU, if any, with the bit in the bitmap set to ‘1’, or with the associated COUNT value less than the value of FMC field as successfully delivered, and discard the PDCP SDU.

Currently, there is no mechanism for supporting a packet discarding operation in a PDCP layer due to a packet loss. Embodiments of the present application aim to solve the above-mentioned issue. Specifically, in some embodiments of the present application, the receiving PDCP entity may detect a packet loss and decide to discard some other packets which have already been received in the receiving buffer. In some further embodiments of the present application, the transmitting PDCP entity may be informed by the peer receiving PDCP entity about the packet discarding decision and stop the relevant packet transmission. In some other embodiments of the present application, the transmitting PDCP entity may decide to discard and stop transmitting some packets and inform the receiving PDCP entity. In some other embodiments of the present application, the PDCP packet discarding operation can be based on a COUNT value, an offset value related to the COUNT value, an ADU index, a number in unit, and/or importance level information carried in the PDCP packet header.

In some cases, a GOP may be deemed as one kind of an ADU, and packets belonging to the same ADU are correlated to each other. In the embodiments of the present application, parameters related to an ADU (e.g., an index value of an ADU, “ADUIndexToDiscard”, and etc.) may be replaced by or applicable for parameters related to a GOP, without departing from the spirit and scope of the disclosure. For example, in some embodiments, an index value of an ADU may be changed or modified to an index value of a GOP. In some embodiments, “ADUIndexToDiscard” may be changed or modified to “GOPIndexToDiscard”. In some embodiments, “NumberInUnitToDiscard” associated with an ADU may be changed or modified to “NumberInUnitToDiscard” associated with a GOP. In some embodiments, “ImportanceToDiscard” associated with an ADU may be changed or modified to “ImportanceToDiscard” associated with a GOP. The embodiments with any of such kind of parameter modifications may also solve the above-mentioned issue.

A receiving side of a PDCP entity may also be named as “a PDCP Rx entity”, “an Rx PDCP entity”, “a PDCP receiving entity”, “a receiving PDCP entity”, or the like. A transmitting side of a PDCP entity may also be named as “a PDCP Tx entity”, “a Tx PDCP entity”, “a PDCP transmitting entity”, “a transmitting PDCP entity”, or the like.

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

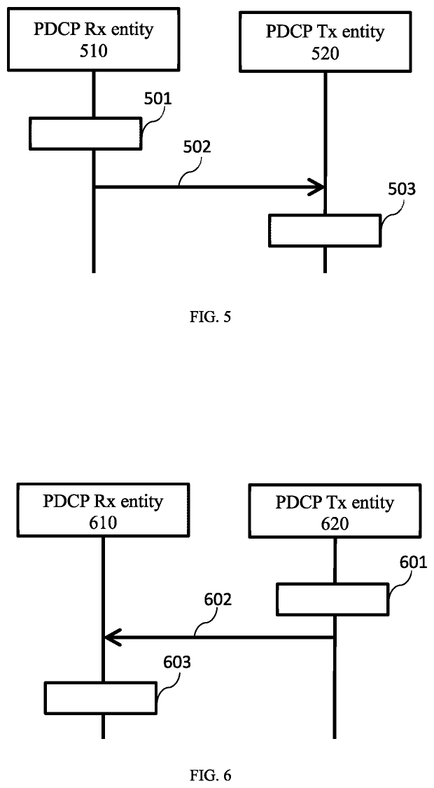

FIG. 2 illustrates an exemplary block diagram of an apparatus according to some embodiments of the present application. As shown in FIG. 2, the apparatus 200 may include at least one processor 204 and at least one transceiver 202 coupled to the processor 204. The at least one transceiver 202 may be a wired transceiver or a wireless transceiver. The apparatus 200 may be a PDCP receiving entity or a PDCP transmitting entity as described in embodiments of FIGS. 5 and 6 as follows.

Although in this figure, elements such as the at least one transceiver 202 and the processor 204 are described in the singular, the plural is contemplated unless a limitation to the singular is explicitly stated. In some embodiments of the present application, the transceiver 202 may be divided into two devices, such as a receiving circuitry and a transmitting circuitry. In some embodiments of the present application, the apparatus 200 may further include an input device, a memory, and/or other components.

In some embodiments of the present application, the apparatus 200 may be a PDCP receiving entity (e.g., PDCP Rx entity 510 or PDCP Rx entity 610 as shown and illustrated in FIG. 5 or FIG. 6). The processor 204 of the PDCP receiving entity may be configured: to detect a packet loss or to receive, via the transceiver 202 from a PDCP transmitting entity (e.g., PDCP Tx entity 520 or PDCP Tx entity 620 as shown and illustrated in FIG. 5 or FIG. 6), parameter information regarding a discarding operation of the PDCP receiving entity. The packet loss or the discarding operation is associated with a packet. The processor 204 of the PDCP receiving entity may be further configured to perform the discarding operation to discard a further packet related to the packet in a receiving buffer, in response to detecting the packet loss or in response to receiving the parameter information.

In following text, the packet may be named as “the 1st packet”, and the further packet is named as “the 2nd packet”, for simplicity. According to some embodiments, the 1st packet may be at least one of:
(1) a PDCP packet data unit (PDU);
(2) a PDCP service data unit (SDU); or
(3) a packet to be discarded by the PDCP transmitting entity based on a timer (e.g., timer discardTimer) expiry.

According to some embodiments, the 2nd packet may be at least one of a PDCP PDU or a PDCP SDU. In some embodiments, the 1st packet and the 2nd packet belong to one application data unit (ADU). For example, the 1st packet and the 2nd packet have the same ADU index value. In some other embodiments, the 1st packet and the 2nd packet belong to one group of picture (GOP). For example, the 1st packet and the 2nd packet have the same GOP index value.

According to some embodiments, the parameter information may be carried via at least one of: physical uplink control channel (PUCCH) signalling; or a PDCP control PDU. The parameter information received by the PDCP receiving entity may include at least one of:
(1) An index value (which is marked as “the 1st index value” for simplicity) of an ADU (which is marked as “the 1st ADU” for simplicity) to which the 1st packet belongs. For example, the 1st index value may be “ADUIndexToDiscard” in embodiments in FIGS. 5 and 6.
(2) An index number (which is marked as “the 1st index number” for simplicity) of the 1st packet in a group of packets belonging to the 1st ADU. For example, the 1st index number may be “NumberInUnitToDiscard” in embodiments in FIGS. 5 and 6.
(3) An importance level (which is marked as “the 1st importance level” for simplicity) of the 1st packet. For example, the 1st importance level may be “ImportanceToDiscard” in embodiments in FIGS. 5 and 6. For instance, the 1st importance level is configured by a network node.
(4) A count value (which is marked as “the 1st count value” for simplicity) of the 1st packet. For example, the 1st count value may be “CountToDiscard” in embodiments in FIGS. 5 and 6.
(5) An offset value (which is marked as “the 1st offset value” for simplicity) related to the 1st count value of the 1st packet. For example, the 1st offset value may be “Offset” in embodiments in FIGS. 5 and 6.

In some embodiments, in response to receiving the parameter information from the PDCP transmitting entity and in response to the parameter information including the 1st index value (e.g., ADUIndexToDiscard) of the 1st ADU to which the 1st packet belongs, during performing the discarding operation of the PDCP receiving entity, the processor 204 of the PDCP receiving entity may be configured to check whether “an index value (which is marked as “the 2nd index value” for simplicity) of an ADU (which is marked as “the 2nd ADU” for simplicity) to which the 2nd packet belongs” is equal to “the 1st index value of the 1st ADU” (e.g., ADUIndexToDiscard). In response to the 2nd index value of the 2nd ADU being equal to the 1st index value of the 1st ADU, the processor 204 of the PDCP receiving entity may be configured to discard the 2nd packet in the receiving buffer.

In some further embodiments, in response to receiving the parameter information from the PDCP transmitting entity and in response to the parameter information including the 1st index value of the 1st ADU (e.g., ADUIndexToDiscard) and the 1st index number of the 1st packet (e.g., NumberInUnitToDiscard), during performing the discarding operation of the PDCP receiving entity, the processor 204 of the PDCP receiving entity may be configured:
(1) to check whether “the 2nd index value of the 2nd ADU to which the 2nd packet belongs” is equal to the 1st index value of the 1st ADU;
(2) to check whether “an index number (which is marked as “the 2nd index number” for simplicity) of the 2nd packet in the group of packets belonging to the 1st ADU” is greater than “the 1st index number of the 1st packet”, in response to the 2nd index value of the 2nd ADU being equal to the 1st index value of the 1st ADU; and
(3) to discard the 2nd packet in the receiving buffer, in response to the 2nd index number of the 2nd packet being greater than the 1st index number of the 1st packet.

In some other embodiments, in response to receiving the parameter information from the PDCP transmitting entity and in response to the parameter information including the 1st index value of the 1st ADU (e.g., ADUIndexToDiscard) and the 1st importance level of the 1st packet (e.g., ImportanceToDiscard), during performing the discarding operation of the PDCP receiving entity, the processor 204 of the PDCP receiving entity may be configured:
(1) to check whether “the 2nd index value of the 2nd ADU to which the 2nd packet belongs” is equal to “the 1st index value of the 1st ADU” (e.g., ADUIndexToDiscard);
(2) to check whether “an importance level (which is marked as “the 2nd importance level” for simplicity) of the 2nd packet” is less than “the 1st importance level of the 1st packet” (e.g., ImportanceToDiscard), in response to the 2nd index value of the 2nd ADU being equal to the 1st index value of the 1st ADU; and
(3) to discard the 2nd packet in the receiving buffer, in response to the 2nd importance level of the 2nd packet being less than the 1st importance level of the 1 st packet.

In some additional embodiments, in response to receiving the parameter information from the PDCP transmitting entity and in response to the parameter information including the 1st count value of the 1st packet (e.g., CountToDiscard) and the 1st offset value related to the 1st count value (e.g., Offset), during performing the discarding operation of the PDCP receiving entity, the processor 204 of the PDCP receiving entity may be configured:
(1) to check whether a count value (which is marked as “the 2nd count value” for simplicity) of the 2nd packet is greater than the 1st count value of the 1st packet (e.g., COUNT CountToDiscard);
(2) to check whether “the 2nd count value of the 2nd packet minus the 1st offset value related to the 1st count value” is less than or equal to “the 1st count value of the 1st packet” (e.g., ‘Count-Offset’=CountToDiscard), in response to the 2nd count value of the 2nd packet being greater than the 1st count value of the 1st packet; and
(3) to discard the 2nd packet in the receiving buffer, in response to “the 2nd count value of the 2nd packet minus the 1st offset value” being less than or equal to “the 1st count value of the 1st packet”.

In yet some additional embodiments, in response to receiving the parameter information from the PDCP transmitting entity and in response to the parameter information including the 1st count value of the 1st packet (e.g., CountToDiscard), during performing the discarding operation of the PDCP receiving entity, the processor 204 of the PDCP receiving entity may be configured:
(1) to determine “the 2nd count value of the 2nd packet” and “an offset value (which is marked as “the 2nd offset value” for simplicity) related to the 2nd count value” based on packet header information of the 2nd packet;
(2) to check whether “the 2nd count value of the 2nd packet” is greater than “the 1st count value of the 1st packet” (e.g., COUNT CountToDiscard);
(3) to check whether “the 2nd count value of the 2nd packet minus the 2nd offset value related to the 2nd count value” is less than or equal to “the 1st count value of the 1st packet” (e.g., ‘Count-Offset’=CountToDiscard), in response to the 2nd count value of the 2nd packet being greater than the 1st count value of the 1st packet; and
(4) to discard the 2nd packet in the receiving buffer, in response to “the 2nd count value of the 2nd packet minus the 2nd offset value” being less than or equal to “the 1st count value of the 1st packet”.

According to some embodiments, in response to detecting the packet loss associated with the 1st packet, during performing the discarding operation of the PDCP receiving entity, the processor 204 of the PDCP receiving entity may be configured:
(1) to check whether “the 2nd index value of the 2nd ADU to which the 2nd packet belongs” is equal to “the 1st index value of the 1st ADU to which the 1st packet belongs”; and
(2) to discard the 2nd packet in the receiving buffer, in response to the 2nd index value of the 2nd ADU being equal to the 1st index value of the 1st ADU.

According to some further embodiments, in response to detecting the packet loss associated with the 1st packet, during performing the discarding operation of the PDCP receiving entity, the processor 204 of the PDCP receiving entity may be configured:
(1) to check whether “the 2nd index value of the 2nd ADU to which the 2nd packet belongs” is equal to “the 1st index value of the 1st ADU to which the 1st packet belongs”;
(2) to check whether “the 2nd index number of the 2nd packet in the group of packets belonging to the 1st ADU” is greater than “the 1st index number of the 1st packet in a group of packets belonging to the 1st ADU”, in response to the 2nd index value of the 2nd ADU being equal to the 1st index value of the 1st ADU; and
(3) to discard the 2nd packet in the receiving buffer, in response to the 2nd index number of the 2nd packet being greater than the 1st index number of the 1st packet.

According to some other embodiments, in response to detecting the packet loss associated with the 1st packet, during performing the discarding operation of the PDCP receiving entity, the processor 204 of the PDCP receiving entity may be configured:
(1) to check whether “the 2nd index value of the 2nd ADU to which the 2nd packet belongs” is equal to “the 1st index value of the 1st ADU to which the 1st packet belongs”; and
(2) to check whether “the 2nd importance level of the 2nd packet” is less than “the 1st importance level of the 1st packet”, in response to the 2nd index value of the 2nd ADU being equal to the 1st index value of the 1st ADU; and
(3) to discard the 2nd packet in the receiving buffer, in response to the 2nd importance level being less than the 1st importance level.

According to some additional embodiments, in response to detecting the packet loss associated with the 1st packet, during performing the discarding operation of the PDCP receiving entity, the processor 204 of the PDCP receiving entity may be configured:
(1) to determine “the 2nd count value of the 2nd packet” and “the 2nd offset value related to the 2nd count value” based on packet header information of the 2nd packet;
(2) to check whether “the 2nd count value of the 2nd packet” is greater than “the 1st count value of the 1st packet” (e.g., COUNT CountToDiscard);
(3) to check whether “the 2nd count value minus the 2nd offset value” is less than or equal to “the 1st count value” (e.g., ‘Count-Offset’=CountToDiscard), in response to the 2nd count value being greater than the 1st count value; and
(4) to discard the 2nd packet in the receiving buffer, in response to “the 2nd count value minus the 2nd offset value” being less than or equal to the 1st count value.

According to some embodiments, the processor 204 of the PDCP receiving entity may be configured: to generate further parameter information regarding a discarding operation of the PDCP transmitting entity; and to transmit the further parameter information via the transceiver 202 to the PDCP transmitting entity. The further discarding operation is associated with the 1st packet. The further parameter information may be carried via at least one of PUCCH signalling or a PDCP control PDU. The further parameter information may include at least one of:
(1) a largest one between “the 1st index value of the 1st ADU” and “the 2nd index value of the 2nd ADU”;
(2) a largest one between “the 1st index number of the 1st packet” and “the 2nd index number of the 2nd packet”;
(3) a largest one between “the 1st importance level of the 1st packet” and “the 2nd importance level of the 2nd packet”;
(4) a largest one between “the 1st count value of the 1st packet” and “the 2nd count value of the 2nd packet”; or
(5) the 2nd offset value related to the 2nd count value of the 2nd packet.

According to some embodiments, in response to discarding the 2nd packet in the receiving buffer, the processor 204 of the PDCP receiving entity may be configured to perform at least one of:
(1) setting a receive state variable (e.g., RX_DELIV in embodiments in FIGS. 5 and 6) to a count value of a PDCP SDU that has not been delivered to an upper layer and has not been discarded at the PDCP receiving entity, wherein the count value of the PDCP SDU is greater than or equal to a reordering timer associated receive state variable (e.g., COUNTvalue=RX_REORD); or
(2) updating a next receive state variable (e.g., RX_NEXT in embodiments in FIGS. 5 and 6) to a count value following a largest count value among remaining packets in the receiving buffer; or
(3) updating the reordering timer associated receive state variable (e.g., RX_REORD) to the next receive state variable (e.g., RX_NEXT), in response to the receive state variable being less than the next receive state variable (e.g., RX_DELIV RX_NEXT).

According to some embodiments, the processor 204 of the PDCP receiving entity may be configured:
(1) to check whether “an index value (which is marked as “the 3rd index value” for simplicity) of another ADU (which is marked as “the 3rd ADU” for simplicity) to which another packet (which is marked as “the 3rd packet” for simplicity) belongs” is equal to “the 1st index value of the 1st ADU to which the 1st packet belongs” (e.g., ADUIndexToDiscard), in response to receiving the 3rd packet from the PDCP transmitting entity; and
(2) not to store the 3rd packet into the receiving buffer and to discard the 3rd packet, in response to the 3rd index value of the 3rd ADU being equal to the 1st index value of the 1st ADU.

According to some other embodiments, the processor 204 of the PDCP receiving entity may be configured:
(1) to check whether “the 3rd index value of the 3rd ADU to which the 3rd packet belongs” is equal to “the 1st index value of the 1st ADU to which the 1st packet belongs”, in response to receiving the 3rd packet from the PDCP transmitting entity;
(2) to check whether “an index number (which is marked as “the 3rd index number” for simplicity) of the 3rd packet in a group of packets belonging to the 3rd ADU” is greater than “the 1st index number of the 1st packet in a group of packets belonging to the 1st ADU”, in response to the 3rd index value of the 3rd ADU being equal to the 1st index value of the 1st ADU; and
(3) not to store the 3rd packet into the receiving buffer and to discard the 3rd packet, in response to the 3rd index number of the 3rd packet being greater than the 1st index number of the 1st packet.

According to some further embodiments, the processor 204 of the PDCP receiving entity may be configured to:
(1) to check whether “the 3rd index value of the 3rd ADU to which the 3rd packet belongs” is equal to “the 1st index value of a first ADU to which the 1st packet belongs”, in response to receiving the 3rd packet from the PDCP transmitting entity;
(2) to check whether “an importance level (which is marked as “the 3rd importance level” for simplicity) of the 3rd packet” is less than “the 1st importance level of the 1st packet”, in response to the 3rd index value of the 3rd ADU being equal to the 1st index value of the 1st ADU; and
(3) not to store the 3rd packet into the receiving buffer and to discard the 3rd packet, in response to the 3rd importance level being less than the 1st importance level.

According to some additional embodiments, the processor 204 of the PDCP receiving entity may be configured to:
(1) to determine a count value (which is marked as “the 3rd count value” for simplicity) of the 3rd packet and a offset value (which is marked as “the 3rd offset value” for simplicity) related to the 3rd count value based on packet header information of the 3rd packet, in response to receiving the 3rd packet from the PDCP transmitting entity;
(2) to check whether “the 3rd count value of the 3rd packet” is greater than “the 1st count value of the 1st packet”;
(3) to check whether “the 3rd count value minus the 3rd offset value” is less than or equal to the 1st count value of the 1st packet, in response to the 3rd count value being greater than the 1st count value; and
(4) not to store the 3rd packet into the receiving buffer and to discard the 3rd packet, in response to “the 3rd count value minus the 3rd offset value” being less than or equal to the 1st count value.

According to yet some additional embodiments, the processor 204 of the PDCP receiving entity may be configured:
(1) to determine “the 3rd count value of the 3rd packet” based on packet header information of the 3rd packet, in response to receiving the 3rd packet from the PDCP transmitting entity;
(2) to check whether “the 3rd count value of the 3rd packet” is greater than “the 1st count value of the 1st packet”;
(3) to check whether “the 3rd count value minus the 1st offset value related to the 1st count value of the 1st packet” is less than or equal to “the 1st count value of the 1st packet”, in response to the 3rd count value being greater than the 1st count value and in response to the 1st parameter information including the 1st offset value related to the 1st count value of the 1st packet; and
(4) not to store the 3rd packet into the receiving buffer and to discard the 3rd packet, in response to “the 3rd count value minus the 1st offset value” being less than or equal to the 1st count value.

According to yet some additional embodiments, the processor 204 of the PDCP receiving entity may be configured receive, via the transceiver 202 from a network node, configuration information regarding whether the discarding operation of the PDCP receiving entity is supported for a radio bearer.

In some embodiments of the present application, the apparatus 200 may be a PDCP transmitting entity (e.g., PDCP Tx entity 520 or PDCP Tx entity 620 as shown and illustrated in FIG. 5 or FIG. 6). The processor 204 of the PDCP transmitting entity may be configured: to detect a packet loss, to determine to perform a discarding operation of the PDCP transmitting entity, or to receive, via the transceiver 202 from a PDCP receiving entity (e.g., PDCP Rx entity 510 or PDCP Rx entity 610 as shown and illustrated in FIG. 5 or FIG. 6), parameter information regarding the discarding operation of the PDCP transmitting entity, wherein the packet loss or the discarding operation is associated with a packet (which is marked as “the 1st packet” for simplicity). The processor 204 of the PDCP transmitting entity may be further configured to stop transmitting a further packet (which is marked as “the 2nd packet” for simplicity) related to the packet in a transmitting buffer and to perform a further discarding operation to discard the further packet, “in response to detecting the packet loss” or “in response to determining to perform the discarding operation” or “in response to receiving the parameter information”. The parameter information may be carried via at least one of PUCCH signalling or a PDCP control PDU. Specific examples are described in embodiments of FIGS. 5 and 6 as follows.

According to some embodiments, the 1st packet may be at least one of: (1) a PDCP PDU; (2) a PDCP SDU; or (3) a packet to be discarded by the PDCP transmitting entity based on a timer (e.g., timer discardTimer) expiry. According to some embodiments, the 2nd packet may be at least one of: a PDCP PDU; or a PDCP SDU. In some embodiments, the 1st packet and the 2nd packet belong to one ADU or one GOP. For example, the 1st packet and the 2nd packet have the same ADU index value or the same GOP index value.

According to some embodiments, the processor 204 of the PDCP transmitting entity may be configured to receive, via the transceiver 202 from a network node, configuration information regarding whether the further discarding operation of the PDCP transmitting entity is supported for a radio bearer. In some embodiments, the radio bearer is not configured with an out of order delivery variable (e.g., outOfOrderDelivery).

According to some embodiments, in response to detecting the packet loss associated with the 1st packet or in response to determining to perform the discarding operation, during performing the further discarding operation of the PDCP transmitting entity, the processor 204 of the PDCP transmitting entity may be configured:
(1) to check whether “an index value (which is marked as “the 2nd index value” for simplicity) of an ADU (which is marked as “the 2nd ADU” for simplicity) to which the 2nd packet belongs” is equal to “the 1st index value of the 1st ADU to which the 1st packet belongs” (e.g., ADUIndexToDiscard); and
(2) to discard the 2nd packet in the transmitting buffer, in response to the 2nd index value of the 2nd ADU being equal to the 1st index value of the 1st ADU.

According to some embodiments, in response to detecting the packet loss associated with the 1st packet or in response to determining to perform the discarding operation, during performing the further discarding operation of the PDCP transmitting entity, the processor 204 of the PDCP transmitting entity may be configured:
(1) to check whether “the 2nd index value of the 2nd ADU to which the 2nd packet belongs” is equal to “the 1st index value of the 1st ADU to which the 1st packet belongs” (e.g., ADUIndexToDiscard);
(2) to check whether “an index number (which is marked as “the 2nd index number” for simplicity) of the 2nd packet in the group of packets belonging to the 1st ADU” is greater than “the 1st index number of the 1st packet in a group of packets belonging to the 1st ADU” (e.g., NumberInUnitToDiscard), in response to the 2nd index value of the 2nd ADU being equal to the 1st index value of the 1st ADU; and
(3) to discard the 2nd packet in the transmitting buffer, in response to the 2nd index number of the 2nd packet being greater than the 1st index number of the 1st packet.

According to some embodiments, in response to detecting the packet loss associated with the 1st packet or in response to determining to perform the discarding operation, during performing the further discarding operation of the PDCP transmitting entity, the processor 204 of the PDCP transmitting entity may be configured:
(1) to check whether “the 2nd index value of the 2nd ADU to which the 2nd packet belongs” is equal to “the 1st index value of the 1st ADU to which the 1st packet belongs” (e.g., ADUIndexToDiscard);
(2) to check whether “an importance level (which is marked as “the 2nd importance level” for simplicity) of the 2nd packet” is less than “the 1st importance level of the 1st packet” (e.g., ImportanceToDiscard), in response to the 2nd index value of the 2nd ADU being equal to the 1st index value of the 1st ADU; and
(3) to discard the 2nd packet in the transmitting buffer, in response to the 2nd importance level being less than the 1st importance level.

According to some embodiments, in response to detecting the packet loss associated with the 1st packet or in response to determining to perform the discarding operation, during performing the further discarding operation of the PDCP transmitting entity, the processor 204 of the PDCP transmitting entity may be configured:
(1) to determine a count value (which is marked as “the 2nd count value” for simplicity) of the 2nd packet and an offset value (which is marked as “the 2nd offset value” for simplicity) related to the 2nd count value based on packet header information of the 2nd packet;
(2) to check whether “the 2nd count value of the 2nd packet” is greater than “the 1st count value of the 1st packet” (e.g., COUNT CountToDiscard);
(3) to check whether “the 2nd count value minus the 2nd offset value related to the 2nd count value” is less than or equal to “the 1st count value of the 1st packet” (e.g., ‘Count-Offset’=CountToDiscard), in response to the 2nd count value being greater than the 1st count value; and
(4) to discard the 2nd packet in the transmitting buffer, in response to “the 2nd count value minus the 2nd offset value” being less than or equal to the 1st count value.

According to some embodiments, the processor 204 of the PDCP transmitting entity may be configured to transmit, via the transceiver 202 to a PDCP receiving entity, further parameter information regarding a discarding operation of the PDCP receiving entity. The discarding operation of the PDCP receiving entity is associated with the 1st packet. The further parameter information may be carried via at least one of PUCCH signalling or a PDCP control PDU. The further parameter information may include at least one of:
(1) the 2nd index value of the 2nd ADU to which the 2nd packet belongs;
(2) the 2nd index number of the 2nd packet;
(3) the 2nd importance level of the 2nd packet;
(4) the 2nd count value of the 2nd packet; or
(5) the 2nd offset value related to the 2nd count value.

According to some embodiments, the processor 204 of the PDCP transmitting entity is configured to determine to perform the discarding operation based on an expiry of a discard timer (e.g., discardTimer) for the 1st packet. According to some embodiments, the processor 204 of the PDCP transmitting entity is configured to detect the packet loss associated with the 1st packet based on a reception of a PDCP status report indicating the packet loss of the 1st packet.

According to some embodiments, the parameter information received by the PDCP transmitting entity includes at least one of:
(1) An index value (which is marked as “the 1st index value” for simplicity) of an ADU (which is marked as “the 1st ADU” for simplicity) to which the 1st packet belongs, e.g., “ADUIndexToDiscard” in embodiments in FIGS. 5 and 6.
(2) An index number (which is marked as “the 1st index number” for simplicity) of the 1st packet in a group of packets belonging to the 1st ADU, e.g., “NumberInUnitToDiscard” in embodiments in FIGS. 5 and 6.
(3) An importance level (which is marked as “the 1st importance level” for simplicity) of the 1st packet, e.g., “ImportanceToDiscard” in embodiments in FIGS. 5 and 6. For instance, the importance level is configured by a network node.
(4) A count value (which is marked as “the 1st count value” for simplicity) of the 1st packet, e.g., “CountToDiscard” in embodiments in FIGS. 5 and 6.
(5) An offset value (which is marked as “the 1st offset value” for simplicity) related to the 1st count value of the 1st packet, e.g., “Offset” in embodiments in FIGS. 5 and 6.

In some embodiments, in response to receiving the parameter information from the PDCP receiving entity and in response to the parameter information including the 1st index value of the 1st ADU (e.g., ADUIndexToDiscard), during performing the further discarding operation of the PDCP transmitting entity, the processor 204 of the PDCP transmitting entity is configured:
(1) to check whether “an index value (which is marked as “the 2nd index value” for simplicity) of an ADU (which is marked as “the 2nd ADU” for simplicity) to which the 2nd packet belongs” is equal to “the 1st index value of the 1st ADU” (e.g., ADUIndexToDiscard); and
(2) to discard the 2nd packet in the transmitting buffer, in response to the 2nd index value of the 2nd ADU being equal to the 1st index value of the 1st ADU.

In some embodiments, in response to receiving the parameter information from the PDCP receiving entity and in response to the parameter information including the 1st index value of the 1st ADU (e.g., ADUIndexToDiscard) and the 1st index number of the 1st packet (e.g., NumberInUnitToDiscard), during performing the further discarding operation of the PDCP transmitting entity, the processor 204 of the PDCP transmitting entity is configured:
(1) to check whether “the 2nd index value of the 2nd ADU to which the 2nd packet belongs” is equal to “the 1st index value of the 1st ADU” (e.g., ADUIndexToDiscard);
(2) to check whether “an index number (which is marked as “the 2nd index number” for simplicity) of the 2nd packet in the group of packets belonging to the 1st ADU” is greater than “the 1st index number of the 1st packet” (e.g., NumberInUnitToDiscard), in response to the 2nd index value of the 2nd ADU being equal to the 1st index value of the 1st ADU; and
(3) to discard the 2nd packet in the transmitting buffer, in response to the 2nd index number of the 2nd packet being greater than the 1st index number of the 1st packet.

In some embodiments, in response to receiving the parameter information from the PDCP receiving entity and in response to the parameter information including the 1st index value of the 1st ADU (e.g., ADUIndexToDiscard) and the 1st importance level of the 1st packet (e.g., ImportanceToDiscard), during performing the further discarding operation of the PDCP transmitting entity, the processor 204 of the PDCP transmitting entity is configured:
(1) to check whether “the 2nd index value of the 2nd ADU to which the 2nd packet belongs” is equal to “the 1st index value of the 1st ADU” (e.g., ADUIndexToDiscard);
(2) to check whether “an importance level (which is marked as “the 2nd importance level” for simplicity) of the 2nd packet” is less than “the 1st importance level of the 1st packet” (e.g., ImportanceToDiscard), in response to the 2nd index value of the 2nd ADU being equal to the 1st index value of the 1st ADU; and
(3) to discard the 2nd packet in the transmitting buffer, in response to the 2nd importance level being less than the 1st importance level.

In some embodiments, in response to receiving the parameter information from the PDCP receiving entity and in response to the parameter information including the 1st count value of the 1st packet (e.g., CountToDiscard) and the 1st offset value related to the 1st count value (e.g., Offset), during performing the further discarding operation of the PDCP transmitting entity, the processor 204 of the PDCP transmitting entity is configured:
(1) to check whether “a count value (which is marked as “the 2nd count value” for simplicity) of the 2nd packet” is greater than “the 1st count value of the 1st packet” (e.g., COUNT CountToDiscard);
(2) to check whether “the 2nd count value minus the 1st offset value related to the 1st count value” is less than or equal to the 1st count value, in response to the 2nd count value being greater than the 1st count value (e.g., ‘Count-Offset’=CountToDiscard); and
(3) to discard the 2nd packet in the transmitting buffer, in response to “the 2nd count value minus the 1st offset value” being less than or equal to the 1st count value.

In some embodiments, in response to receiving the parameter information from the PDCP receiving entity and in response to the parameter information including the 1st count value of the 1st packet (e.g., CountToDiscard), during performing the further discarding operation of the PDCP transmitting entity, the processor 204 of the PDCP transmitting entity is configured:
(1) to determine the 2nd count value of the 2nd packet and the 2nd offset value related to the 2nd count value based on packet header information of the 2nd packet;
(2) to check whether “the 2nd count value of the 2nd packet” is greater than “the 1st count value of the 1st packet”;
(3) to check whether “the 2nd count value minus the 2nd offset value related to the 2nd count value” is less than or equal to “the 1st count value of the 1st packet”, in response to the 2nd count value being greater than the 1st count value; and
(4) to discard the 2nd packet in the transmitting buffer, in response to “the 2nd count value minus the 2nd offset value” being less than or equal to “the 1st count value of the 1st packet”.

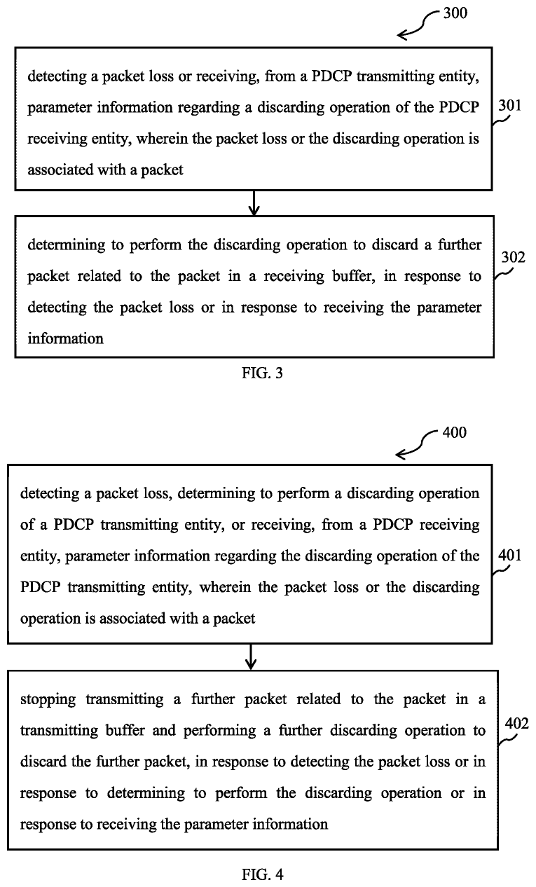

In some embodiments of the present application, the apparatus 200 may include at least one non-transitory computer-readable medium. In some embodiments of the present disclosure, the non-transitory computer-readable medium may have stored thereon computer-executable instructions to cause a processor to implement the method with respect to a PDCP receiving entity or a PDCP transmitting entity as described above. For example, the computer-executable instructions, when executed, cause the processor 204 interacting with the transceiver 202, so as to perform operations of the methods, e.g., as described in view of FIGS. 3-6.

FIG. 3 illustrates an exemplary flow chart for a packet discarding operation according to some embodiments of the present application. The method 300 may be performed by a PDCP receiving entity (e.g., PDCP Rx entity 510 or PDCP Rx entity 610 as shown and illustrated in FIG. 5 or FIG. 6). Although described with respect to a PDCP receiving entity, it should be understood that other devices may also be configured to perform the method as shown and illustrated in FIG. 3.

In the exemplary method 300 illustrated in FIG. 3, in operation 301, a PDCP receiving entity (e.g., PDCP Rx entity 510 as shown and illustrated in FIG. 5) detects a packet loss or receives, from a PDCP transmitting entity (e.g., PDCP Tx entity 520 as shown and illustrated in FIG. 5), parameter information regarding a discarding operation of the PDCP receiving entity. The packet loss or the discarding operation is associated with a packet (which is marked as “the 1st packet” for simplicity). In operation 302, the PDCP receiving entity determines to perform the discarding operation to discard a further packet (which is marked as “the 2nd packet” for simplicity) related to the 1st packet in a receiving buffer, in response to detecting the packet loss or in response to receiving the parameter information from the PDCP transmitting entity. Specific examples are described in embodiments of FIGS. 5 and 6 as follows.

According to some embodiments of the method 300 illustrated in FIG. 3, the 1 st packet may be at least one of: (1) a PDCP PDU; (2) a PDCP SDU; or (3) a packet to be discarded by the PDCP transmitting entity based on a timer expiry (e.g., timer discardTimer). The 2nd packet may be at least one of: a PDCP PDU; or a PDCP SDU. In some embodiments, the 1st packet and the 2nd packet belong to one ADU, e.g., the 1st packet and the 2nd packet have the same ADU index value. In some other embodiments, the 1st packet and the 2nd packet belong to one GOP, e.g., the 1st packet and the 2nd packet have the same GOP index value.

According to some embodiments of the method 300 illustrated in FIG. 3, the parameter information may be carried via at least one of PUCCH signalling or a PDCP control PDU. The parameter information received by the PDCP receiving entity may include at least one of following parameters.
(1) An index value (which is marked as “the 1st index value” for simplicity) of an ADU (which is marked as “the 1st ADU” for simplicity) to which the 1st packet belongs, e.g., “ADUIndexToDiscard” in embodiments in FIGS. 5 and 6.
(2) An index number (which is marked as “the 1st index number” for simplicity) of the 1st packet in a group of packets belonging to the 1st ADU, e.g., “NumberInUnitToDiscard” in embodiments in FIGS. 5 and 6.
(3) An importance level (which is marked as “the 1st importance level” for simplicity) of the 1st packet, e.g., “ImportanceToDiscard” in embodiments in FIGS. 5 and 6. For instance, the 1st importance level is configured by a network node.
(4) A count value (which is marked as “the 1st count value” for simplicity) of the 1st packet, e.g., “CountToDiscard” in embodiments in FIGS. 5 and 6.
(5) An offset value (which is marked as “the 1st offset value” for simplicity) related to the 1st count value of the 1st packet, e.g., “Offset” in embodiments in FIGS. 5 and 6.

In some embodiments of the method 300 illustrated in FIG. 3, in response to receiving the parameter information from the PDCP transmitting entity and in response to the parameter information including the 1st index value (e.g., ADUIndexToDiscard) of the 1st ADU to which the 1st packet belongs, during performing the discarding operation, the PDCP receiving entity further checks whether “an index value (which is marked as “the 2nd index value” for simplicity) of an ADU (which is marked as “the 2nd ADU” for simplicity) to which the 2nd packet belongs” is equal to “the 1st index value of the 1st ADU” (e.g., ADUIndexToDiscard). In response to the 2nd index value of the 2nd ADU being equal to the 1st index value of the 1st ADU, the PDCP receiving entity may discard the 2nd packet in the receiving buffer.

In some further embodiments of the method 300 illustrated in FIG. 3, in response to receiving the parameter information from the PDCP transmitting entity and in response to the parameter information including the 1st index value of the 1st ADU (e.g., ADUIndexToDiscard) and the 1st index number of the 1st packet (e.g., NumberInUnitToDiscard), during performing the discarding operation, the PDCP receiving entity may:
(1) check whether “the 2nd index value of the 2nd ADU to which the 2nd packet belongs” is equal to the 1st index value of the 1st ADU;
(2) check whether “an index number (which is marked as “the 2nd index number” for simplicity) of the 2nd packet in the group of packets belonging to the 1st ADU” is greater than “the 1st index number of the 1st packet”, in response to the 2nd index value of the 2nd ADU being equal to the 1st index value of the 1st ADU; and
(3) discard the 2nd packet in the receiving buffer, in response to the 2nd index number of the 2nd packet being greater than the 1st index number of the 1st packet.

In some other embodiments of the method 300 illustrated in FIG. 3, in response to receiving the parameter information from the PDCP transmitting entity and in response to the parameter information including the 1st index value of the 1st ADU (e.g., ADUIndexToDiscard) and the 1st importance level of the 1st packet (e.g., ImportanceToDiscard), during performing the discarding operation of the PDCP receiving entity, the PDCP receiving entity may:
(1) check whether “the 2nd index value of the 2nd ADU to which the 2nd packet belongs” is equal to “the 1st index value of the 1st ADU” (e.g., ADUIndexToDiscard);
(2) check whether “an importance level (which is marked as “the 2nd importance level” for simplicity) of the 2nd packet” is less than “the 1st importance level of the 1st packet” (e.g., ImportanceToDiscard), in response to the 2nd index value of the 2nd ADU being equal to the 1st index value of the 1st ADU; and
(3) discard the 2nd packet in the receiving buffer, in response to the 2nd importance level of the 2nd packet being less than the 1st importance level of the 1st packet.

In some additional embodiments of the method 300 illustrated in FIG. 3, in response to receiving the parameter information from the PDCP transmitting entity and in response to the parameter information including the 1st count value of the 1st packet (e.g., CountToDiscard) and the 1st offset value related to the 1st count value (e.g., Offset), during performing the discarding operation of the PDCP receiving entity, the PDCP receiving entity may:
(1) check whether a count value (which is marked as “the 2nd count value” for simplicity) of the 2nd packet is greater than the 1st count value of the 1st packet (e.g., COUNT CountToDiscard);
(2) check whether “the 2nd count value of the 2nd packet minus the 1st offset value related to the 1st count value” is less than or equal to “the 1st count value of the 1st packet” (e.g., ‘Count-Offset’=CountToDiscard), in response to the 2nd count value of the 2nd packet being greater than the 1st count value of the 1st packet; and
(3) discard the 2nd packet in the receiving buffer, in response to “the 2nd count value of the 2nd packet minus the 1st offset value” being less than or equal to the 1st count value of the 1st packet.

In yet some additional embodiments of the method 300 illustrated in FIG. 3, in response to receiving the parameter information from the PDCP transmitting entity and in response to the parameter information including the 1st count value of the 1st packet (e.g., CountToDiscard), during performing the discarding operation of the PDCP receiving entity, the PDCP receiving entity may:
(1) determine “the 2nd count value of the 2nd packet” and “an offset value (which is marked as “the 2nd offset value” for simplicity) related to the 2nd count value” based on packet header information of the 2nd packet;
(2) check whether “the 2nd count value of the 2nd packet” is greater than “the 1st count value of the 1st packet” (e.g., COUNT CountToDiscard);
(3) check whether “the 2nd count value of the 2nd packet minus the 2nd offset value related to the 2nd count value” is less than or equal to “the 1st count value of the 1st packet” (e.g., ‘Count-Offset’=CountToDiscard), in response to the 2nd count value of the 2nd packet being greater than the 1st count value of the 1st packet; and
(4) discard the 2nd packet in the receiving buffer, in response to “the 2nd count value of the 2nd packet minus the 2nd offset value” being less than or equal to “the 1st count value of the 1st packet”.

According to some embodiments of the method 300 illustrated in FIG. 3, in response to detecting the packet loss associated with the 1st packet, during performing the discarding operation of the PDCP receiving entity, the PDCP receiving entity may:
(1) check whether “the 2nd index value of the 2nd ADU to which the 2nd packet belongs” is equal to “the 1st index value of the 1st ADU to which the 1st packet belongs”; and
(2) discard the 2nd packet in the receiving buffer, in response to the 2nd index value of the 2nd ADU being equal to the 1st index value of the 1st ADU.

According to some further embodiments of the method 300 illustrated in FIG. 3, in response to detecting the packet loss associated with the 1st packet, during performing the discarding operation of the PDCP receiving entity, the PDCP receiving entity may:
(1) check whether “the 2nd index value of the 2nd ADU to which the 2nd packet belongs” is equal to “the 1st index value of the 1st ADU to which the 1st packet belongs”;
(2) check whether “the 2nd index number of the 2nd packet in the group of packets belonging to the 1st ADU” is greater than “the 1st index number of the 1st packet in a group of packets belonging to the 1st ADU”, in response to the 2nd index value of the 2nd ADU being equal to the 1st index value of the 1st ADU; and
(3) discard the 2nd packet in the receiving buffer, in response to the 2nd index number of the 2nd packet being greater than the 1st index number of the 1st packet.

According to some other embodiments of the method 300 illustrated in FIG. 3, in response to detecting the packet loss associated with the 1st packet, during performing the discarding operation of the PDCP receiving entity, the PDCP receiving entity may:
(1) check whether “the 2nd index value of the 2nd ADU to which the 2nd packet belongs” is equal to “the 1st index value of the 1st ADU to which the 1st packet belongs”;
(2) check whether “the 2nd importance level of the 2nd packet” is less than “the 1st importance level of the 1st packet”, in response to the 2nd index value of the 2nd ADU being equal to the 1st index value of the 1st ADU; and
(3) discard the 2nd packet in the receiving buffer, in response to the 2nd importance level being less than the 1st importance level.

According to some additional embodiments of the method 300 illustrated in FIG. 3, in response to detecting the packet loss associated with the 1st packet, during performing the discarding operation of the PDCP receiving entity, the PDCP receiving entity may:
(1) determine “the 2nd count value of the 2nd packet” and “the 2nd offset value related to the 2nd count value” based on packet header information of the 2nd packet;
(2) check whether “the 2nd count value of the 2nd packet” is greater than “the 1st count value of the 1st packet” (e.g., COUNT CountToDiscard);
(3) check whether “the 2nd count value minus the 2nd offset value” is less than or equal to “the 1st count value” (e.g., ‘Count-Offset’=CountToDiscard), in response to the 2nd count value being greater than the 1st count value; and
(4) discard the 2nd packet in the receiving buffer, in response to “the 2nd count value minus the 2nd offset value” being less than or equal to the 1st count value.

According to some embodiments of the method 300 illustrated in FIG. 3, the PDCP receiving entity may generate further parameter information regarding a discarding operation of the PDCP transmitting entity, and transmit the further parameter information to the PDCP transmitting entity. The further discarding operation is associated with the 1st packet. The further parameter information may be carried via at least one of PUCCH signalling or a PDCP control PDU. The further parameter information may include at least one of:
(1) a largest one between “the 1st index value of the 1st ADU” and “the 2nd index value of the 2nd ADU”;
(2) a largest one between “the 1st index number of the 1st packet” and “the 2nd index number of the 2nd packet”;
(3) a largest one between “the 1st importance level of the 1st packet” and “the 2nd importance level of the 2nd packet”;
(4) a largest one between “the 1st count value of the 1st packet” and “the 2nd count value of the 2nd packet”; or
(5) the 2nd offset value related to the 2nd count value of the 2nd packet.

According to some embodiments of the method 300 illustrated in FIG. 3, in response to discarding the 2nd packet in the receiving buffer, the PDCP receiving entity may perform at least one of:
(1) setting a receive state variable (e.g., RX_DELIV in embodiments in FIGS. 5 and 6) to a count value of a PDCP SDU that has not been delivered to an upper layer and has not been discarded at the PDCP receiving entity, wherein the count value of the PDCP SDU is greater than or equal to a reordering timer associated receive state variable (e.g., COUNT value>=RX_REORD); or
(2) updating a next receive state variable (e.g., RX_NEXT in embodiments in FIGS. 5 and 6) to a count value following a largest count value among remaining packets in the receiving buffer; or
(3) updating the reordering timer associated receive state variable (e.g., RX_REORD) to the next receive state variable (e.g., RX_NEXT), in response to the receive state variable being less than the next receive state variable (e.g., RX_DELIV RX_NEXT).

According to some embodiments of the method 300 illustrated in FIG. 3, the PDCP receiving entity may:
(1) check whether “an index value (which is marked as “the 3rd index value” for simplicity) of another ADU (which is marked as “the 3rd ADU” for simplicity) to which another packet (which is marked as “the 3rd packet” for simplicity) belongs” is equal to “the 1st index value of the 1st ADU to which the 1st packet belongs” (e.g., ADUIndexToDiscard), in response to receiving the 3rd packet from the PDCP transmitting entity; and
(2) “not store the 3rd packet into the receiving buffer” and “discard the 3rd packet”, in response to the 3rd index value of the 3rd ADU being equal to the 1st index value of the 1st ADU.

According to some other embodiments of the method 300 illustrated in FIG. 3, the PDCP receiving entity may:
(1) check whether “the 3rd index value of the 3rd ADU to which the 3rd packet belongs” is equal to “the 1st index value of the 1st ADU to which the 1st packet belongs” (e.g., ADUIndexToDiscard), in response to receiving the 3rd packet from the PDCP transmitting entity;
(2) check whether “an index number (which is marked as “the 3rd index number” for simplicity) of the 3rd packet in a group of packets belonging to the 3rd ADU” is greater than “the 1st index number of the 1st packet in a group of packets belonging to the 1st ADU” (e.g., NumberInUnitToDiscard), in response to the 3rd index value of the 3rd ADU being equal to the 1st index value of the 1st ADU; and
(3) “not store the 3rd packet into the receiving buffer” and “discard the 3rd packet”, in response to the 3rd index number of the 3rd packet being greater than the 1st index number of the 1st packet.

According to some further embodiments of the method 300 illustrated in FIG. 3, the PDCP receiving entity may:
(1) check whether “the 3rd index value of the 3rd ADU to which the 3rd packet belongs” is equal to “the 1st index value of a first ADU to which the 1st packet belongs”, in response to receiving the 3rd packet from the PDCP transmitting entity;
(2) check whether “an importance level (which is marked as “the 3rd importance level” for simplicity) of the 3rd packet” is less than “the 1st importance level of the 1st packet”, in response to the 3rd index value of the 3rd ADU being equal to the 1st index value of the 1st ADU; and
(3) “not store the 3rd packet into the receiving buffer” and “discard the 3rd packet”, in response to the 3rd importance level being less than the 1st importance level.

According to some additional embodiments of the method 300 illustrated in FIG. 3, the PDCP receiving entity may:
(1) determine a count value (which is marked as “the 3rd count value” for simplicity) of the 3rd packet and a offset value (which is marked as “the 3rd offset value” for simplicity) related to the 3rd count value based on packet header information of the 3rd packet, in response to receiving the 3rd packet from the PDCP transmitting entity;
(2) check whether “the 3rd count value of the 3rd packet” is greater than “the 1st count value of the 1st packet”;
(3) check whether “the 3rd count value minus the 3rd offset value” is less than or equal to the 1st count value of the 1st packet, in response to the 3rd count value being greater than the 1st count value; and
(4) not to store the 3rd packet into the receiving buffer and to discard the 3rd packet, in response to “the 3rd count value minus the 3rd offset value” being less than or equal to the 1st count value.

According to yet some additional embodiments of the method 300 illustrated in FIG. 3, the PDCP receiving entity may:
(1) determine “the 3rd count value of the 3rd packet” based on packet header information of the 3rd packet, in response to receiving the 3rd packet from the PDCP transmitting entity;
(2) check whether “the 3rd count value of the 3rd packet” is greater than “the 1st count value of the 1st packet”;
(3) check whether “the 3rd count value minus the 1st offset value related to the 1st count value of the 1st packet” is less than or equal to “the 1st count value of the 1st packet”, in response to the 3rd count value being greater than the 1st count value and in response to the 1st parameter information including the 1st offset value related to the 1st count value of the 1st packet; and
(4) not store the 3rd packet into the receiving buffer and discard the 3rd packet, in response to “the 3rd count value minus the 1st offset value” being less than or equal to the 1st count value.

According to yet some additional embodiments of the method 300 illustrated in FIG. 3, the PDCP receiving entity may receive, from a network node, configuration information regarding whether the discarding operation of the PDCP receiving entity is supported for a radio bearer.

It is contemplated that the method 300 illustrated in FIG. 3 may include other operation(s) not shown, for example, any operation(s) described with respect to FIGS. 2 and 4-6.

Details described in all other embodiments of the present application (for example, details regarding a mechanism for supporting a packet discarding operation in a PDCP layer due to a packet loss) are applicable for the embodiments of FIG. 3. Moreover, details described in the embodiments of FIG. 3 are applicable for all embodiments of FIGS. 1, 2, and 4-6. It should be appreciated by persons skilled in the art that the sequence of the operations in exemplary procedure in the embodiments of FIG. 3 may be changed and some of the operations in exemplary procedure in the embodiments of FIG. 3 may be eliminated or modified, without departing from the spirit and scope of the disclosure.

FIG. 4 illustrates a further exemplary flow chart for a packet discarding operation according to some embodiments of the present application. The embodiments of FIG. 4 may be performed by a PDCP transmitting entity (e.g., PDCP Tx entity 520 or PDCP Tx entity 620 as shown and illustrated in FIG. 5 or FIG. 6). Although described with respect to a PDCP transmitting entity, it should be understood that other devices may be configured to perform a method similar to that of FIG. 4.

In the exemplary method 400 as shown in FIG. 4, in operation 401, a PDCP transmitting entity (e.g., PDCP Tx entity 520 as shown and illustrated in FIG. 5) detects a packet loss or receives, from a PDCP receiving entity (e.g., PDCP Rx entity 510 as shown and illustrated in FIG. 5), parameter information regarding a discarding operation of the PDCP transmitting entity. The packet loss or the discarding operation is associated with a packet (which is marked as “the 1st packet” for simplicity). In operation 402 as shown in FIG. 4, the PDCP transmitting entity stops transmitting a further packet (which is marked as “the 2nd packet” for simplicity) related to the 1st packet in a transmitting buffer and performs the discarding operation to discard the further packet, in response to detecting the packet loss or in response to receiving the parameter information. According to some embodiments of the method 400 illustrated in FIG. 4, the parameter information may be carried via at least one of PUCCH signalling or a PDCP control PDU. Specific examples are described in embodiments of FIGS. 5 and 6 as follows.

According to some embodiments of the method 400 illustrated in FIG. 4, the 1 st packet may be at least one of: (1) a PDCP PDU; (2) a PDCP SDU; or (3) a packet to be discarded by the PDCP transmitting entity based on a timer expiry (e.g., timer discardTimer). According to some embodiments, the 2nd packet may be at least one of: a PDCP PDU; or a PDCP SDU. In some embodiments, the 1st packet and the 2nd packet belong to one ADU, e.g., the 1st packet and the 2nd packet have the same ADU index value. In some other embodiments, the 1st packet and the 2nd packet belong to one GOP, e.g., the 1st packet and the 2nd packet have the same GOP index value.

In some embodiments of the method 400 illustrated in FIG. 4, the PDCP transmitting entity may receive, from the network node, configuration information regarding whether the discarding operation of the PDCP transmitting entity is supported for a radio bearer. For instance, the radio bearer may be not configured with an out of order delivery variable (e.g., outOfOrderDelivery).

According to some embodiments of the method 400 illustrated in FIG. 4, in response to detecting the packet loss associated with the 1st packet or in response to determining to perform the discarding operation, during performing the further discarding operation of the PDCP transmitting entity, the PDCP transmitting entity may:
(1) check whether “an index value (which is marked as “the 2nd index value” for simplicity) of an ADU (which is marked as “the 2nd ADU” for simplicity) to which the 2nd packet belongs” is equal to “the 1st index value of the 1st ADU to which the 1st packet belongs” (e.g., ADUIndexToDiscard); and
(2) discard the 2nd packet in the transmitting buffer, in response to the 2nd index value of the 2nd ADU being equal to the 1st index value of the 1st ADU.

According to some embodiments of the method 400 illustrated in FIG. 4, in response to detecting the packet loss associated with the 1st packet, during performing the further discarding operation of the PDCP transmitting entity, the PDCP transmitting entity may:
(1) check whether “the 2nd index value of the 2nd ADU to which the 2nd packet belongs” is equal to “the 1st index value of the 1st ADU to which the 1st packet belongs” (e.g., ADUIndexToDiscard);
(2) check whether “an index number (which is marked as “the 2nd index number” for simplicity) of the 2nd packet in the group of packets belonging to the 1st ADU” is greater than “the 1st index number of the 1st packet in a group of packets belonging to the 1st ADU” (e.g., NumberInUnitToDiscard), in response to the 2nd index value of the 2nd ADU being equal to the 1st index value of the 1st ADU; and
(3) discard the 2nd packet in the transmitting buffer, in response to the 2nd index number of the 2nd packet being greater than the 1st index number of the 1st packet.

According to some embodiments of the method 400 illustrated in FIG. 4, in response to detecting the packet loss associated with the 1st packet, during performing the further discarding operation of the PDCP transmitting entity, the PDCP transmitting entity may:
(1) check whether “the 2nd index value of the 2nd ADU to which the 2nd packet belongs” is equal to “the 1st index value of the 1st ADU to which the 1st packet belongs” (e.g., ADUIndexToDiscard);
(2) check whether “an importance level (which is marked as “the 2nd importance level” for simplicity) of the 2nd packet” is less than “the 1st importance level of the 1st packet” (e.g., ImportanceToDiscard), in response to the 2nd index value of the 2nd ADU being equal to the 1st index value of the 1st ADU; and
(3) discard the 2nd packet in the transmitting buffer, in response to the 2nd importance level being less than the 1st importance level.

According to some embodiments of the method 400 illustrated in FIG. 4, in response to detecting the packet loss associated with the 1st packet, during performing the further discarding operation of the PDCP transmitting entity, the PDCP transmitting entity may:
(1) determine a count value (which is marked as “the 2nd count value” for simplicity) of the 2nd packet and an offset value (which is marked as “the 2nd offset value” for simplicity) related to the 2nd count value based on packet header information of the 2nd packet;
(2) check whether “the 2nd count value of the 2nd packet” is greater than “the 1st count value of the 1st packet” (e.g., COUNT CountToDiscard);
(3) check whether “the 2nd count value minus the 2nd offset value related to the 2nd count value” is less than or equal to “the 1st count value of the 1st packet” (e.g., ‘Count-Offset’=CountToDiscard), in response to the 2nd count value being greater than the 1st count value; and
(4) discard the 2nd packet in the transmitting buffer, in response to “the 2nd count value minus the 2nd offset value” being less than or equal to the 1st count value.

According to some embodiments of the method 400 illustrated in FIG. 4, the PDCP transmitting entity may transmit, to a PDCP receiving entity, further parameter information regarding a discarding operation of the PDCP receiving entity. The discarding operation of the PDCP receiving entity is associated with the 1st packet. The further parameter information may be carried via at least one of PUCCH signalling or a PDCP control PDU. The further parameter information may include at least one of:
(1) the 2nd index value of the 2nd ADU to which the 2nd packet belongs;
(2) the 2nd index number of the 2nd packet;
(3) the 2nd importance level of the 2nd packet;
(4) the 2nd count value of the 2nd packet; or
(5) the 2nd offset value related to the 2nd count value.

According to some embodiments of the method 400 illustrated in FIG. 4, the PDCP transmitting entity determines to perform the discarding operation based on an expiry of a discard timer (e.g., discardTimer) for the 1st packet. According to some embodiments of the method 400 illustrated in FIG. 4, the PDCP transmitting entity detects the packet loss associated with the 1st packet based on a reception of a PDCP status report indicating the packet loss of the 1st packet.

According to some embodiments of the method 400 illustrated in FIG. 4, the parameter information received by the PDCP transmitting entity includes at least one of:
(1) An index value (which is marked as “the 1st index value” for simplicity) of an ADU (which is marked as “the 1st ADU” for simplicity) to which the 1st packet belongs, e.g., “ADUIndexToDiscard” in embodiments in FIGS. 5 and 6.
(2) An index number (which is marked as “the 1st index number” for simplicity) of the 1st packet in a group of packets belonging to the 1st ADU, e.g., “NumberInUnitToDiscard” in embodiments in FIGS. 5 and 6.
(3) An importance level (which is marked as “the 1st importance level” for simplicity) of the 1st packet, e.g., “ImportanceToDiscard” in embodiments in FIGS. 5 and 6. For instance, the importance level is configured by a network node.
(4) A count value (which is marked as “the 1st count value” for simplicity) of the 1st packet, e.g., “CountToDiscard” in embodiments in FIGS. 5 and 6.
(5) An offset value (which is marked as “the 1st offset value” for simplicity) related to the 1st count value of the 1st packet, e.g., “Offset” in embodiments in FIGS. 5 and 6.

In some embodiments of the method 400 illustrated in FIG. 4, in response to receiving the parameter information from the PDCP receiving entity and in response to the parameter information including the 1st index value of the 1st ADU (e.g., ADUIndexToDiscard), during performing the further discarding operation of the PDCP transmitting entity, the PDCP transmitting entity may:
(1) check whether “an index value (which is marked as “the 2nd index value” for simplicity) of an ADU (which is marked as “the 2nd ADU” for simplicity) to which the 2nd packet belongs” is equal to “the 1st index value of the 1st ADU” (e.g., ADUIndexToDiscard); and
(2) discard the 2nd packet in the transmitting buffer, in response to the 2nd index value of the 2nd ADU being equal to the 1st index value of the 1st ADU.

In some embodiments of the method 400 illustrated in FIG. 4, in response to receiving the parameter information from the PDCP receiving entity and in response to the parameter information including the 1st index value of the 1st ADU (e.g., ADUIndexToDiscard) and the 1st index number of the 1st packet (e.g., NumberInUnitToDiscard), during performing the further discarding operation of the PDCP transmitting entity, the PDCP transmitting entity may:
(1) check whether “the 2nd index value of the 2nd ADU to which the 2nd packet belongs” is equal to “the 1st index value of the 1st ADU” (e.g., ADUIndexToDiscard);
(2) check whether “an index number (which is marked as “the 2nd index number” for simplicity) of the 2nd packet in the group of packets belonging to the 1st ADU” is greater than “the 1st index number of the 1st packet” (e.g., NumberInUnitToDiscard), in response to the 2nd index value of the 2nd ADU being equal to the 1st index value of the 1st ADU; and
(3) to discard the 2nd packet in the transmitting buffer, in response to the 2nd index number of the 2nd packet being greater than the 1st index number of the 1st packet.

In some embodiments of the method 400 illustrated in FIG. 4, in response to receiving the parameter information from the PDCP receiving entity and in response to the parameter information including the 1st index value of the 1st ADU (e.g., ADUIndexToDiscard) and the 1st importance level of the 1st packet (e.g., ImportanceToDiscard), during performing the further discarding operation of the PDCP transmitting entity, the PDCP transmitting entity may:
(1) check whether “the 2nd index value of the 2nd ADU to which the 2nd packet belongs” is equal to “the 1st index value of the 1st ADU” (e.g., ADUIndexToDiscard);
(2) check whether “an importance level (which is marked as “the 2nd importance level” for simplicity) of the 2nd packet” is less than “the 1st importance level of the 1st packet” (e.g., ImportanceToDiscard), in response to the 2nd index value of the 2nd ADU being equal to the 1st index value of the 1st ADU; and
(3) discard the 2nd packet in the transmitting buffer, in response to the 2nd importance level being less than the 1st importance level.

In some embodiments of the method 400 illustrated in FIG. 4, in response to receiving the parameter information from the PDCP receiving entity and in response to the parameter information including the 1st count value of the 1st packet (e.g., CountToDiscard) and the 1st offset value related to the 1st count value (e.g., Offset), during performing the further discarding operation of the PDCP transmitting entity, the PDCP transmitting entity may:
(1) check whether “a count value (which is marked as “the 2nd count value” for simplicity) of the 2nd packet” is greater than “the 1st count value of the 1st packet” (e.g., COUNT CountToDiscard);
(2) check whether “the 2nd count value minus the 1st offset value related to the 1st count value” is less than or equal to the 1st count value, in response to the 2nd count value being greater than the 1st count value (e.g., ‘Count-Offset’=CountToDiscard); and
(3) discard the 2nd packet in the transmitting buffer, in response to “the 2nd count value minus the 1st offset value” being less than or equal to the 1st count value.

In some embodiments of the method 400 illustrated in FIG. 4, in response to receiving the parameter information from the PDCP receiving entity and in response to the parameter information including the 1st count value of the 1st packet (e.g., CountToDiscard), during performing the further discarding operation of the PDCP transmitting entity, the PDCP transmitting entity may:
(1) determine the 2nd count value of the 2nd packet and the 2nd offset value related to the 2nd count value based on packet header information of the 2nd packet;
(2) check whether “the 2nd count value of the 2nd packet” is greater than “the 1st count value of the 1st packet”;
(3) check whether “the 2nd count value minus the 2nd offset value related to the 2nd count value” is less than or equal to “the 1st count value of the 1st packet”, in response to the 2nd count value being greater than the 1st count value; and
(4) discard the 2nd packet in the transmitting buffer, in response to “the 2nd count value minus the 2nd offset value” being less than or equal to “the 1st count value of the 1st packet”.

It is contemplated that the method illustrated in FIG. 4 may include other operation(s) not shown, for example, any operation(s) described with respect to FIGS. 2, 3, 5, and 6.

Details described in all other embodiments of the present application (for example, details regarding a mechanism for supporting a packet discarding operation in a PDCP layer due to a packet loss) are applicable for the embodiments of FIG. 4. Moreover, details described in the embodiments of FIG. 4 are applicable for all embodiments of FIGS. 1-3, 5, and 6. It should be appreciated by persons skilled in the art that the sequence of the operations in exemplary procedure in the embodiments of FIG. 4 may be changed and some of the operations in exemplary procedure in the embodiments of FIG. 4 may be eliminated or modified, without departing from the spirit and scope of the disclosure.

FIGS. 5 and 6 show some specific embodiments of the methods as shown and illustrated in FIGS. 2-4. The embodiments of FIGS. 5 and 6 assume that the packets are related to one XR service and correlated with each other. For example, each packet (i.e., a PDCP PDU) is associated with an ADU or GOP index, number in the unit (i.e., the number of frames in the same ADU or GOP), and an importance level. One ADU or GOP has multiple frames correlated to each other. Packets belonging to the same ADU or GOP are correlated to each other, e.g., for instance, if the I-frame packet is lost, the user will not be able to decode the subsequent P-frames and B-frames. Packets belonging to the same ADU or GOP are of different importance levels, e.g., the I-frame packets are of a higher importance level than P-frames and B-frames. In the embodiments of FIGS. 5 and 6, a packet can be a PDU, a SDU, or a packet to be discarded by the PDCP transmitting entity based on a timer expiry (e.g., timer discardTimer).

FIG. 5 illustrates an exemplary flow chart of a packet discarding operation in a PDCP receiving entity according to some embodiments of the present application.

In step 501 as shown in FIG. 5, PDCP Rx entity 510 makes a packet discarding decision. In step 502, PDCP Rx entity 510 transmits “parameter information regarding a discarding operation of PDCP Tx entity 520” to PDCP Tx entity 520.

For instance, if PDCP Rx entity 510 (e.g., which may be a PDCP receiving entity) determines a packet loss or decides to discard relevant received packets in the receiving buffer (which may also be named as a reception buffer), PDCP Rx entity 510 may transmit “parameter information regarding the packet loss and a discarding operation of PDCP Rx entity 510” to PDCP Tx entity 520 (e.g., which may be a PDCP transmitting entity). The parameter information can be transmitted via PUCCH signalling and/or a PDCP control PDU (e.g., PDCP status report or new PDCP control PDU). In some embodiments, the parameter information may imply either:
1) CountToDiscard value and optionally an Offset value which is related to the “CountToDiscard” value.
2) ADUIndexToDiscard value, and optionally NumberInUnitToDiscard value or ImportanceToDiscard value.

In some embodiments, CountToDiscard, ADUIndexToDiscard, NumberInUnitToDiscard, and/or ImportanceToDiscard are set to values indicated or decided by PDCP Rx entity 510.

According to some embodiments of FIG. 5, PDCP Rx entity 510 determines that a PDCP PDU or a PDCP SDU is lost if timer t-Reordering expires and the PDCP PDU or the PDCP SDU with associated COUNT value(s)<RX_REORD is still missing. PDCP Rx entity 510 may discard one or multiple received PDCP packets that are dependent on the lost PDCP packet (e.g., belong to the same ADU or GOP). In these embodiments, a PDCP packet discarding operation of PDCP Rx entity 510 is triggered by PDCP Rx entity 510.

In some embodiments of FIG. 5, whether to discard a PDCP packet according to the lost PDCP packet is allowed for a given data radio bearer that is configured by a network node. It might also imply whether the PDCP header will include information about correlation with other PDCP packets (e.g., an offset value means that it depends on an offset number of a PDCP packet before it, an ADU or GOP index, a number in unit, or importance level information). In some embodiments, the radio bearer allowing a PDCP packet discarding operation shall not be configured with outOfOrderDelivery. If outOfOrderDelivery is configured, a PDCP SDU will not be buffered in PDCP Rx entity 510, and thus, the PDCP packet discarding operation is not applicable.

In step 503 as shown in FIG. 5, upon receiving the parameter information from PDCP Rx entity 510, PDCP Tx entity 520 may discard packet(s) (e.g., PDU(s)) in the transmitting buffer which is correlated to the discarded packet(s) indicated by PDCP Rx entity 510. In such embodiments, a PDCP packet discarding operation of PDCP Tx entity 520 is triggered by receiving the parameter information from PDCP Rx entity 510. For instance, PDCP Tx entity 520 may perform one of:
1) Stop transmitting and discard the rest packets in the current transmission buffer (does not impact future arriving packets) with associated COUNT and Offset values fulfilling ‘COUNT-Offset’>=CountToDiscard.
2) Stop transmitting and discard the rest packets (including both packets in the current transmission buffer and future arriving packets) associated with the ADU index same as ADUIndexToDiscard.
3) Stop transmitting and discard the rest packets (including both packets in the current transmission buffer and future arriving packets) associated with the ADU index same as ADUIndexToDiscard and with number in unit greater than NumberInUnitToDiscard, if provided.
4) Stop transmitting and discard the rest packets (including both packets in the current transmission buffer and future arriving packets) associated with the ADU index same as ADUIndexToDiscard and with importance level lower than ImportanceToDiscard, if provided.

According to some embodiments of FIG. 5, the PDCP data PDU header contains an offset value, which means that the current PDCP packet has dependency on the offset number of PDCP packets before it, and any loss of the previous offset number of PDCP packets will make the current PDCP packet useless.

In some embodiments, when a PDCP packet is received from a lower layer, PDCP Rx entity 510 shall check whether the associated COUNT value and Offset value fulfilling ‘COUNT’-‘Offset’=CountToDiscard. If so, PDCP Rx entity 510 shall discard the received PDCP packet and not put it into the receiving buffer.

According to some embodiments of FIG. 5, if the receiving PDCP entity determines a packet loss of a PDCP packet associated with “COUNT=CountLost”, PDCP Rx entity 510 will discard PDCP packets with associated COUNT and offset values that fulfil ‘COUNT’−‘Offset’<=CountLost in the receiving buffer. For example, if a PDCP data PDU header contains “COUNT value=100” and “Offset value=10”, any loss of a PDCP packet with a COUNT value within a range of “90˜99” will make the current PDCP PDU useless and thus can be discarded. PDCP Rx entity 510 may update CountToDiscard to the largest COUNT associated with the discarded PDCP packets.

In some embodiments, upon discarding the relevant PDCP packets, among the remaining PDCP packets in the reception buffer, PDCP Rx entity 510 may perform any or a combination of following operations:
1) RX_DELIV is updated to a COUNT value of the first PDCP SDU which has not been delivered to upper layers with the COUNT value>=RX_REORD.
2) RX_NEXT is updated to a COUNT value following the largest COUNT value among the remaining PDCP packets in the reception buffer.
3) If RX_DELIV<RX_NEXT, RX_REORD is updated to RX_NEXT.

According to some embodiments of FIG. 5, if the lost packet is associated with a certain ADU/GOP indicated by an ADU/GOP index (e.g., ADUIndexToDiscard) and is the number “N” packet in the ADU/GOP indicated by the number in the unit (e.g., NumberInUnitToDiscard), PDCP Rx entity 510 will discard other packet(s) which belongs to the same ADU/GOP and (optionally) with a number in unit larger than “N”. The information about the lost packet may be indicated by an upper layer of PDCP Rx entity 510 or by PDCP Tx entity 520.

In some embodiments, when a PDCP packet is received from a lower layer, PDCP Rx entity 510 shall check whether the associated ADU index equals to ADUIndexToDiscard and (optionally) the associated number in the unit is larger than NumberInUnitToDiscard. If so, PDCP Rx entity 510 shall discard the received PDCP packet and not put it into the reception buffer. One specific embodiment may be as follows:
After determining the COUNT value of the received PDCP Data PDU=RCVD_COUNT, PDCP Rx entity 510 shall:
   perform deciphering and integrity verification of the PDCP Data PDU using COUNT=RCVD_COUNT;
      if integrity verification fails:
         indicate the integrity verification failure to upper layer;
         discard the PDCP Data PDU and consider it as not received;
   if the associated ADU index equals to ADUIndexToDiscard and (optionally) the associated number in the unit is larger than the NumberInUnitToDiscard
   if RCVD_COUNT<RX_DELIV; or
   if the PDCP Data PDU with COUNT=RCVD_COUNT has been received before:
   discard the PDCP Data PDU;

According to some embodiments of FIG. 5, when PDCP Rx entity 510 detects a PDCP packet reception failure, when timer t-Reordering expires, PDCP Rx entity 510 discards other PDCP packet(s) in the reception buffer with an ADU index that is equal to ADU index associated with the lost PDCP packet and (optionally) the associated number in the unit that is larger than the number in unit associated with the lost PDCP packet; and PDCP Rx entity 510 updates the value of ADUIndexToDiscard and NumberInUnitToDiscard. In some embodiments, the value of ADUIndexToDiscard is updated to the largest ADU index associated with the discarded PDCP packets, and the value of NumberInUnitToDiscard is updated to the largest number in unit value associated with the discarded PDCP packets.

In some embodiments, upon discarding the relevant PDCP packets, among the remaining PDCP packets in the reception buffer, PDCP Rx entity 510 may perform any or a combination of following operations:
1) RX_DELIV is updated to a COUNT value of the first PDCP SDU which has not been delivered to upper layers with the COUNT value>=RX_REORD.
2) RX_NEXT to a COUNT value following the largest COUNT value among the remaining PDCP packets in the reception buffer.
3) If RX_DELIV<RX_NEXT, RX_REORD is updated to RX_NEXT.

One specific embodiment may be as follows:
When t-Reordering expires, PDCP Rx entity 510 shall:
   In case there is PDCP SUD(s) with associated COUNT value(s) RX_REORD, and still missing, discard the PDCP SDU(s) in the PDCP reception buffer with ADU index equals to ADUIndexToDiscard and (optionally) the associated number in the unit is larger than NumberInUnitToDiscard.
   deliver to upper layers in ascending order of the associated COUNT value after performing header decompression, if not decompressed before:
      all stored PDCP SDU(s) with associated COUNT value(s) RX_REORD;
      all stored PDCP SDU(s) with consecutively associated COUNT value(s) starting from RX_REORD;
   update RX_DELIV to the COUNT value of the first PDCP SDU which has not been delivered to upper layers, with COUNT value>=RX_REORD;
   if RX_DELIV<RX_NEXT:
      update RX_REORD to RX_NEXT;
   start t-Reordering.

According to some embodiments of FIG. 5, if the lost packet is associated with a certain ADU/GOP indicated by an ADU/GOP index and is of importance value M, PDCP Rx entity 510 will discard other packet(s) belonging to the same ADU/GOP and of lower importance level than the lost packet importance “M”. The information about the lost packet may be indicated by upper layer of PDCP Rx entity 510 or by PDCP Tx entity 520.

In some embodiments, when a PDCP packet is received from a lower layer, PDCP Rx entity 510 shall check whether the associated ADU index equals to ADUIndexToDiscard and whether the associated importance level below ImportanceToDiscard. If so, PDCP Rx entity 510 shall discard the received PDCP packet and not put it into the receiving buffer.

In some embodiments, when the receiving PDCP entity detects a PDCP packet reception failure upon timer t-Reordering expiry, PDCP Rx entity 510 discards other PDCP packet(s) in the reception buffer with ADU index that is equal to the ADU index associated with the lost PDCP packet and the associated number associated importance level below ImportanceToDiscard; and PDCP Rx entity 510 updates the value of ADUIndexToDiscard.

In an embodiment, the value of ADUIndexToDiscard is updated to the largest ADU index associated with the discarded PDU(s). In an embodiment, upon discarding the relevant PDCP packets, among the remaining PDCP packets in the reception buffer, PDCP Rx entity 510 may perform any or a combination of following operations:
1) RX_DELIV is updated to a COUNT value of the first PDCP SDU which has not been delivered to upper layers with the COUNT value>=RX_REORD.
2) RX_NEXT is updated to a COUNT value following the largest COUNT value among the remaining PDCP packets in the reception buffer.
3) If RX_DELIV<RX_NEXT, RX_REORD is updated to RX_NEXT.

Details described in all other embodiments of the present application (for example, details regarding a mechanism for supporting a packet discarding operation in a PDCP layer due to a packet loss) are applicable for the embodiments of FIG. 5. Moreover, details described in the embodiments of FIG. 5 are applicable for all the embodiments of FIGS. 1-4 and 6.

FIG. 6 illustrates an exemplary flow chart of a packet discarding operation in a PDCP transmitting entity according to some embodiments of the present application. In step 601 as shown in FIG. 6, PDCP Tx entity 620 makes a packet discarding decision. In step 602, PDCP Tx entity 620 transmits “parameter information regarding a discarding operation of PDCP Rx entity 610” to PDCP Rx entity 610. In step 603, PDCP Rx entity 610 discards relevant packets. In some embodiments, the parameter information may imply either:
1) CountToDiscard value and optionally an Offset value which is related to the “CountToDiscard” value.
2) ADUIndexToDiscard value, and optionally NumberInUnitToDiscard value or ImportanceToDiscard value.

In some embodiments, CountToDiscard, ADUIndexToDiscard, NumberInUnitToDiscard, and/or ImportanceToDiscard are set to values indicated or decided by PDCP Tx entity 620.

According to some embodiments of FIG. 6, upon PDCP Tx entity 620 decides to discard one PDCP packet, PDCP Tx entity 620 may also discard other relevant PDCP packets in its transmission buffer. In some embodiments, it is upon network configuration whether a PDCP packet discarding operation at PDCP Tx entity 620 is supported for a radio bearer, such that an offset and/or ADU/GOP information is carried in the PDCP packet header when transmitting.

According to some embodiments of FIG. 6, PDCP Tx entity 620 may decide to discard one PDCP packet, due to any of the following reasons:
1) Timer discardTimer expires for a PDCP SDU (i.e., PDCP Tx entity 620 itself determines to perform a discarding operation based on timer discardTimer).
2) A PDCP status report indicates a missing PDCP SDU (i.e., PDCP Tx entity 620 itself determines to perform a discarding operation based on the PDCP status report).
3) PDCP Rx entity 610 triggers a DCP packet discarding operation and informs PDCP Tx entity 620, e.g., as described in the embodiments of FIG. 5 (i.e., PDCP Tx entity 620 receives parameter information regarding a discarding operation from PDCP Rx entity 610).

According to some embodiments of FIG. 6, PDCP Tx entity 620 will stop transmitting and discard other packets associated with the discarded one. For example, PDCP Tx entity 620 may perform any or a combination of following operations:
1) Stop transmitting and discard the rest packets in the current transmission buffer (does not impact future arriving packets) with associated COUNT and Offset values fulfilling ‘COUNT−Offset’<=CountToDiscard.
2) Stop transmitting and discard the rest packets (including both packets in the current transmission buffer and future arriving packets) associated with the ADU index same as ADUIndexToDiscard.
3) Stop transmitting and discard the rest packets (including both packets in the current transmission buffer and future arriving packets) associated with the ADU index same as ADUIndexToDiscard and with number in unit greater than NumberInUnitToDiscard, if applicable.
4) Stop transmitting and discard the rest packets (including both packets in the current transmission buffer and future arriving packets) associated with the ADU index same as ADUIndexToDiscard and with importance level lower than ImportanceToDiscard, if applicable.

According to some embodiments of FIG. 6, if the PDCP packet discarding operation is triggered by the transmitting PDCP entity itself (e.g., in a case that “timer discardTimer expires for a PDCP SDU” or “a PDCP status report indicates a missing PDCP SDU”), PDCP Tx entity 620 may perform any or a combination of following operations:
1) CountToDiscard is set to a COUNT value associated with the PDCP packet in the transmission buffer which triggers the PDCP packet discarding operation.
2) ADUIndexToDiscard is set to an ADU Index value associated with the PDCP packet in the transmission buffer which triggers the PDCP packet discarding operation.
3) NumberInUnitToDiscard is set to a number in unit value associated with the PDCP packet in the transmission buffer which triggers the PDCP packet discarding operation.
4) ImportanceToDiscard is either set to importance level value associated with the PDCP packet in the transmission buffer which triggers the PDCP packet discard, or set to an ImportanceToDiscard value configured by a network node in advance.

According to some embodiments of FIG. 6, upon receiving the parameter information from PDCP Tx entity 620 about the PDCP packet discarding operation, PDCP Rx entity 610 will discard those PDCP SDU(s) in the reception buffer which is correlated to the discarded PDCP SDU(s) indicated by PDCP Tx entity 620. For example, PDCP Rx entity 610 may:
1) For PDCP SDU(s) in the reception buffer, discard those with associated COUNT and offset values fulfils ‘COUNT’−‘Offset’<=CountToDiscard.
2) For PDCP SDU(s) in the reception buffer, discard those associated with the ADU index same as ADUIndexToDiscard.
3) For PDCP SDU(s) in the reception buffer, discard those associated with the ADU index same as ADUIndexToDiscard and with number in unit larger than NumberInUnitToDiscard, if applicable.
4) For PDCP SDU(s) in the reception buffer, discard those associated with the ADU index same as ADUIndexToDiscard and with importance level lower than ImportanceToDiscard, if applicable.

In some embodiments of FIG. 6, upon discarding the relevant PDCP packets, among the remaining PDCP packets in the reception buffer, PDCP Rx entity 610 may perform any or a combination of following operations:
(1) RX_DELIV is updated to a COUNT value of the first PDCP SDU which has not been delivered to upper layers, with the COUNT value>=RX_REORD.
(2) RX_NEXT is updated to a COUNT value following the largest COUNT value among the remaining PDCP packets in the reception buffer.
(3) If RX_DELIV RX_NEXT, RX_REORD is updated to RX_NEXT.

Details described in all other embodiments of the present application (for example, details regarding a mechanism for supporting a packet discarding operation in a PDCP layer due to a packet loss) are applicable for the embodiments of FIG. 6. Moreover, details described in the embodiments of FIG. 6 are applicable for all the embodiments of FIGS. 1-5.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

What is claimed is:

1. A first apparatus for wireless communication, comprising:
at least one memory; and
at least one processor coupled with the at least one memory and configured to cause the first apparatus to:
detect a packet loss or receive, from a second apparatus, first parameter information regarding a first discarding operation of the first apparatus, wherein the packet loss or the first discarding operation is associated with a first packet; and
perform the first discarding operation to discard a second packet related to the first packet in a receiving buffer, in response to detecting the packet loss or in response to receiving the first parameter information.

2. The first apparatus of claim 1, wherein the first packet and the second packet belong to one application data unit (ADU) or one group of picture (GOP).

3. The first apparatus of claim 1, wherein the first parameter information includes at least one of:
a first index value of a first application data unit (ADU) to which the first packet belongs;
a first index number of the first packet in a group of packets belonging to the first ADU;
a first importance level of the first packet;
a first count value of the first packet; or
a first offset value related to the first count value of the first packet.

4. The first apparatus of claim 3, wherein in response to receiving the first parameter information and in response to the first parameter information including the first count value of the first packet, during performing the first discarding operation, the at least one processor is configured to cause the first apparatus to:
determine a second count value of the second packet and a second offset value related to the second count value based on packet header information of the second packet;
check whether the second count value of the second packet is greater than the first count value of the first packet;
check whether the second count value minus the second offset value related to the second count value is less than or equal to the first count value, in response to the second count value being greater than the first count value; and
discard the second packet in the receiving buffer, in response to the second count value minus the second offset value being less than or equal to the first count value.

5. The first apparatus of claim 4, wherein in response to detecting the packet loss, during performing the first discarding operation, the at least one processor is configured to cause the first apparatus to:
determine a second count value of the second packet and a second offset value related to the second count value based on packet header information of the second packet;
check whether the second count value of the second packet is greater than a first count value of the first packet;
check whether the second count value minus the second offset value is less than or equal to the first count value, in response to the second count value being greater than the first count value; and
discard the second packet in the receiving buffer, in response to the second count value minus the second offset value being less than or equal to the first count value.

6. The first apparatus of claim 5, wherein the at least one processor is configured to cause the first apparatus to:
generate second parameter information regarding a second discarding operation of the second apparatus, wherein the second discarding operation is associated with the first packet, and wherein the second parameter information includes at least one of:
a largest one between the first index value of the first ADU and a second index value of a second ADU;
a largest one between the first index number of the first packet and a second index number of the second packet;
a largest one between the first importance level of the first packet and a second importance level of the second packet;
a largest one between the first count value of the first packet and the second count value of the second packet; or
the second offset value related to the second count value; and
transmit the second parameter information to the second apparatus.

7. The first apparatus of claim 1, wherein the at least one processor is configured to cause the first apparatus to:
determine a third count value of a third packet and a third offset value related to the third count value based on packet header information of the third packet, in response to receiving the third packet from the second apparatus;
check whether the third count value of the third packet is greater than a first count value of the first packet;
check whether the third count value minus the third offset value is less than or equal to the first count value, in response to the third count value being greater than the first count value; and
not store the third packet into the receiving buffer and discard the third packet, in response to the third count value minus the third offset value being less than or equal to the first count value.

8. The first apparatus of claim 1, wherein the at least one processor is configured to cause the first apparatus to receive, from a network node, configuration information regarding whether the first discarding operation is supported for a radio bearer.

9. A second apparatus for wireless communications, comprising:
at least one memory; and
at least one processor coupled with the at least one memory and configured to cause the second apparatus to:
detect a packet loss, determine to perform a first discarding operation of the second apparatus, or receive, from a first apparatus, first parameter information regarding the first discarding operation of the second apparatus, wherein the packet loss or the first discarding operation is associated with a first packet; and
stop transmitting a second packet related to the first packet in a transmitting buffer and perform a second discarding operation to discard the second packet in response to detecting the packet loss, in response to determining to perform the first discarding operation, or in response to receiving the first parameter information.

10. The second apparatus of claim 9, wherein the first packet and the second packet belong to one application data unit (ADU) or one group of picture (GOP).

11. The second apparatus of claim 9, wherein the at least one processor is configured to cause the second apparatus to receive, from a network node, configuration information regarding whether the second discarding operation is supported for a radio bearer.

12. The second apparatus of claim 11, wherein the radio bearer is not configured with an out of order delivery variable.

13. The second apparatus of claim 9, wherein in response to detecting the packet loss or in response to determining to perform the first discarding operation, during performing the second discarding operation, the at least one processor is configured to cause the second apparatus to:
determine a second count value of the second packet and a second offset value related to the second count value based on packet header information of the second packet;
check whether the second count value of the second packet is greater than a first count value of the first packet;
check whether the second count value minus the second offset value related to the second count value is less than or equal to the first count value, in response to the second count value being greater than the first count value; and
discard the second packet in the transmitting buffer, in response to the second count value minus the second offset value being less than or equal to the first count value.

14. The second apparatus of claim 9, wherein the first parameter information includes at least one of:
a first index value of a first application data unit (ADU) to which the first packet belongs;
a first index number of the first packet in a group of packets belonging to the first ADU;
a first importance level of the first packet;
a first count value of the first packet; or
a first offset value related to the first count value of the first packet.

15. (canceled)

16. The second apparatus of claim 9, wherein in response to detecting the packet loss or in response to determining to perform the first discarding operation, during performing the second discarding operation, the at least one processor is configured to cause the second apparatus to:
check whether a second index value of a second application data unit (ADU) to which the second packet belongs is equal to a first index value of a first ADU to which the first packet belongs;
check whether a second importance level of the second packet is less than a first importance level of the first packet, in response to the second index value of the second ADU being equal to the first index value of the first ADU; and
discard the second packet in the transmitting buffer, in response to the second importance level being less than the first importance level.

17. The second apparatus of claim 16, wherein the at least one processor is configured to cause the second apparatus to transmit, to the first apparatus, second parameter information regarding a third discarding operation of the first apparatus, wherein the third discarding operation is associated with the first packet, and wherein the second parameter information comprises at least one of:
the second index value of the second ADU;
a second index number of the second packet;
the second importance level of the second packet;
a second count value of the second packet; or
a second offset value related to the second count value.

18. The second apparatus of claim 17, wherein at least one of the first parameter information or the second parameter information is carried via at least one of physical uplink control channel (PUCCH) signaling or a PDCP control protocol data unit (PDU).

19. The second apparatus of claim 9, wherein the at least one processor is configured to cause the second apparatus to perform the first discarding operation based on an expiry of a discard timer for the first packet.

20. A method performed by a first apparatus, the method comprising:
detecting a packet loss or receiving, from a second apparatus, first parameter information regarding a first discarding operation of the first apparatus, wherein the packet loss or the first discarding operation is associated with a first packet; and
performing the first discarding operation to discard a second packet related to the first packet in a receiving buffer, in response to detecting the packet loss or in response to receiving the first parameter information.

21. A method performed by a second apparatus, the method comprising:
detecting a packet loss, determining to perform a first discarding operation of the second apparatus, or receiving, from a first apparatus, first parameter information regarding the first discarding operation of the second apparatus, wherein the packet loss or the first discarding operation is associated with a first packet; and
stopping transmitting a second packet related to the first packet in a transmitting buffer and performing a second discarding operation to discard the second packet in response to detecting the packet loss, in response to determining to perform the first discarding operation, or in response to receiving the first parameter information.
